(19) United States
(12) Patent Application Publication
(10) Pub. No.: US 2020/0048579 A1
(43) Pub. Date: Feb. 13, 2020

(54) SOLID DETERGENT

(71) Applicant: KEVIN ORCHARD CO., LTD., Ulsan (KR)

(72) Inventors: Seung Jae KANG, Ulsan (KR); Dae Han JEONG, Ulsan (KR)

(21) Appl. No.: 16/454,927

(22) Filed: Jun. 27, 2019

(30) Foreign Application Priority Data
Jun. 12, 2018 (KR) 10-2018-0067437

(51) Int. Cl. C11D 1/28; C11D 3/22; C11D 3/10; C11D 17/00

(52) U.S. Cl. CPC C11D 1/28; C11D 17/0073; C11D 3/10; C11D 3/221

(57) ABSTRACT

One aspect of the present invention provides a solid detergent, which is manufactured by compressing a mixture including 20 to 40 wt % of a sodium lauryl sulfoacetate powder; 50 to 70 wt % of a sugar powder; and 1 to 10 wt % of a sodium hydrogen carbonate powder, into tablets.

### CROSS-REFERENCE TO RELATED APPLICATION

This application claims priority to and the benefit of Korean Patent Application No. 2018-0067437, filed on Jun. 12, 2018, the disclosure of which is incorporated herein by reference in its entirety.

### BACKGROUND

### 1. Field of the Invention

The present invention relates to a solid detergent with excellent environment-friendliness and improved disintegrability and detergency.

### 2. Discussion of Related Art

Surfactants have hydrophobic groups and hydrophilic groups, which can lower the interfacial tension of liquids, and are contained as an essential component to prepare soap, synthetic detergent or cosmetics while being well mixed and dissolved in both oil and water. Surfactants include natural surfactants and synthetic surfactants, and since synthetic surfactants are cheap and have strong detergency, synthetic surfactants are generally used in daily life.

However, a synthetic surfactant has strong detergency, which not only contaminates but also weakens skin lipids, and thus lowers a skin barrier function. For this reason, the penetration of a foreign substance into skin is facilitated, and the moisture in the skin is easily evaporated, so that dry skin and wrinkle formation are promoted, leading to rapid progression of aging.

In addition, the stability of a builder, a preservative, and an artificial fragrance, which have been pointed out as causative materials causing various skin allergies, dermatitis, etc., and are added to increase the function of a detergent manufactured using a synthetic surfactant, is not verified and thus easily exposed to potential hazards. In other words, products including a synthetic surfactant have only focused on the ability of removing pollutants, and aspects such as skin health and environmental protection are not considered at all.

To improve disadvantages of a synthetic surfactant, recently, products including a natural surfactant have been needed and therefore developed. However, the natural surfactant can be highly influenced by external environments, and thus it is difficult to be stored, more expensive than a synthetic surfactant, makes less bubbles. For this reason, such products may have difficulty in stimulating the purchasing power of consumers.

Meanwhile, a kitchen detergent is generally used in the form of a liquid, and a liquid kitchen detergent has a large weight and a large mass, so that it is difficult to be carried or stored. In addition, such a liquid kitchen detergent is generally administered one time to a tool or object for cleaning before complete cleaning, and most of the applied detergent is consumed at the beginning of cleaning, and therefore, it is difficult to maintain detergency in the whole process of cleaning, and when the number of applications of the detergent during cleaning is increased to maintain detergency, more detergent than necessary is used, which is disadvantageous in terms of economic feasibility and environment friendliness.

In addition, since a kitchen detergent is directly in contact with the skin of a user during use, after use, it may remain on the skin, thereby causing a skin disease, and when the kitchen detergent remains on a dish, the detergent ingredient may be directly administered through the mouth of a user, and adversely affect health and hygiene.

Therefore, although a solid-type kitchen detergent was developed, since it is easily contaminated since it is exposed to external environments until completely consumed after use, bacterial proliferation is facilitated and therefore, hygienic management can be difficult. In addition, according to use, the size of the solid-type kitchen detergent is reduced, and thus a user may feel inconvenience during a bubbling process.

For this reason, there is a demand for developing a solid detergent which contains a natural surfactant and thus has excellent environmental friendliness and improved disintegrability and detergency.

### SUMMARY OF THE INVENTION

The present invention is directed to providing a solid detergent with excellent environmental friendliness and improved disintegrability and detergency.

In one aspect, the present invention provides a solid detergent, which is manufactured by compressing a mixture including 20 to 40 wt % of a sodium lauryl sulfoacetate powder; 50 to 70 wt % of a sugar powder; and 1 to 10 wt % of a sodium hydrogen carbonate powder, into tablets.

In one exemplary embodiment, a moisture content of the mixture may be 6 wt % or less.

In one exemplary embodiment, the sugar powder may include dextrose powder.

In one exemplary embodiment, the sugar powder may further include sucrose powder.

In one exemplary embodiment, a content of the sucrose powder among the sugar powder may be 20 to 80 wt %.

In one exemplary embodiment, the sucrose powder may be porous particles.

In one exemplary embodiment, the porous particles may have a porosity of 20 to 80 vol %.

In one exemplary embodiment, the mixture may have an apparent density of 0.5 to 1.5 g/cc, and the solid detergent may have an apparent density of 1.51 to 3.0 g/cc.

In one exemplary embodiment, the solid detergent may have a diameter of 7 to 30 mm.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is the particle size distribution curve of a sodium lauryl sulfoacetate powder according to an exemplary embodiment of the present invention;

FIG. 2 is the particle size distribution curve of a dextrose powder according to an exemplary embodiment of the present invention;

FIG. 3 is the particle size distribution curve of a sodium hydrogen carbonate powder according to an exemplary embodiment of the present invention;

FIG. 4 is the result of measuring the apparent density of a powder mixture according to an exemplary embodiment of the present invention; and

FIG. 5 is the result of measuring the apparent density of a solid detergent according to an exemplary embodiment of the present invention.

### DETAILED DESCRIPTION OF EXEMPLARY EMBODIMENTS

Hereinafter, the present invention will be described in detail with reference to the accompanying drawings. However, the present invention may be embodied in a variety of different forms, and thus, is not limited to the examples to be described below.

In addition, throughout the specification, when one part “includes” a component, it means that it may also include other components instead of excluding the other components unless particularly stated otherwise.

One aspect of the present invention provides a solid detergent, which is manufactured by compressing a mixture including 20 to 40 wt % of a sodium lauryl sulfoacetate powder; 50 to 70 wt % of a sugar powder; and 1 to 10 wt % of a sodium hydrogen carbonate powder, into tablets.

Generally, a detergent may include a surfactant and thus can serve to remove an oil stain when dissolved in water. An interface refers to the boundary between a gas and a liquid, a liquid and a liquid, or a liquid and a solid, and a surfactant may have hydrophilic groups at one side of the molecule and hydrophobic groups at the other side thereof, thereby lowering the surface tension of the interface and thus mitigating an interfacial boundary.

When the surfactant molecules in cleaning are contained at a predetermined concentration or more, micelles, which are aggregates in which hydrophobic groups are present inside and hydrophilic groups are present outside, are formed. The hydrophobic groups that are aggregated in the micelle may attract an oil stain contaminating an object to be cleaned into the micelle, and in rinsing, the oil stain may be removed by water.

Conventional detergents include low-cost synthetic surfactants with excellent detergency, and representatively, a sulfate series such as sodium lauryl sulfate, sodium laureth sulfate, ammonium lauryl sulfate, and ammonium laureth sulfate are widely used.

The sulfate-based surfactant is cheap and has excellent detergency without being highly affected by an external environment. However, when a sulfate-based product is used for a long time, it may be transformed into 1,4-dioxine in the body, and accumulated as a carcinogen, resulting in various types of skin diseases and functional disorders.

Therefore, as the solid detergent includes a natural surfactant, environmental friendliness and a skin protection effect may be realized, and by including a sugar powder and a sodium hydrogen carbonate powder, detergency may be enhanced.

The solid detergent may include a sodium lauryl sulfoacetate powder. The sodium lauryl sulfoacetate is a coconut-derived anionic natural surfactant, which is used in foam baths, shampoos, or cleansing products because of less skin irritation, abundant bubbles and excellent detergency.

Particularly, the Skin Deep Score according to an EWG rating is evaluated as 1, indicating that skin stability is very excellent. In addition, it may maintain a stable formulation when being mixed with another surfactant, and thus may be applied to various products.

The term “EWG rating” used herein refers to a cosmetic ingredient hazardous rating announced by Environmental Working Group (EWG), which is a US non-profit environmental NGO, and specifically, EWG classifies the hazards of cosmetic ingredients into 1 to 10 grades through thorough investigation, and the first and second grades are determined as safe grades.

Meanwhile, a content of the sodium lauryl sulfoacetate powder may be 20 to 40 wt % based on the total weight of the solid detergent. When the content of the sodium lauryl sulfoacetate powder is less than 20 wt %, detergency may be lowered, and when the content of the sodium lauryl sulfoacetate powder is more than 40 wt %, moisturizing power may be lowered.

The solid detergent may include a sugar powder. The sugar powder may be one selected from the group consisting of a monosaccharide, a disaccharide and a combination thereof, preferably, a glucose powder, and more preferably, a dextrose powder.

The monosaccharide is a basic unit of a carbohydrate consisting of one sugar which is no longer hydrolyzed by an acid, a base or an enzyme, is a colorless crystal, water-soluble, and is not dissolved in ether or ethanol. In addition, the monosaccharide is divided into various types according to a carbon number. The most abundant monosaccharide in nature is a hexose, and the types of a hexose include glucose, fructose, and galactose.

The disaccharide is formed when two monosaccharides are joined, and the types of the disaccharide include sucrose, maltose, and lactose. A mixture thereof, that is, a polysaccharide, may be formed by joining many monosaccharides in the form obtained when energy is stored or a structure is formed in an animal and a plant. The polysaccharide may be classified into digestible starch and glycogen and non-digestible cellulose.

A content of the sugar powder may be 50 to 70 wt % based on the total weight of the solid detergent. When the content of the sugar powder is less than 50 wt %, detergency may be lowered, and when the content of the sugar powder is more than 70 wt %, more sugar powder than necessary is contained because no higher effect can be realized.

Meanwhile, the sugar powder is dissolved in water in cleaning such that a pollutant is attached to the sugar molecule and removed, resulting in realization of a synergistic effect with the sodium lauryl sulfoacetate and maximizing detergency. In addition, the sugar powder may be decomposed by microorganisms after cleaning, thereby realizing excellent environmental friendliness and an effect of protecting the skin of a user. Since the sugar powder has high solubility and reactivity when it is a monosaccharide, the sugar powder may be a monosaccharide, and preferably, a glucose powder.

The glucose is produced by hydrolyzing corn starch by heat, an acid and an enzyme, and generally, known as glucose, present as a hexagonal ring having an aldehyde group. There are two types of optical isomers of glucose, that is, a D-form and an L-form. While D-glucose is very abundant in a natural state, L-glucose is not present in a natural state and its production method is very complicated, and therefore, when L-glucose is applied to a detergent, the production costs of the detergent may increase. For this reason, the sugar powder may be a D-glucose powder, that is, a dextrose powder.

The solid detergent may include a sodium hydrogen carbonate powder. The solid detergent is titrated to pH 7.0 to 8.0 with the sodium hydrogen carbonate, such that recontamination of an object to be cleaned may be prevented, the protection effect on a user's skin may be exhibited, and detergency may be enhanced when being used with the sodium lauryl sulfoacetate and the sugar powder. In addition, the sodium hydrogen carbonate absorbs moisture contained in another type of powder, for example, a sugar powder, to aggregate together while mixing and compressing powders for manufacturing the solid detergent, and thus the structural and morphological stability of the solid detergent may be enhanced, and it is possible to provide visual satisfaction to a user by imparting a required level of gloss to the object to be cleaned.

A content of the sodium hydrogen carbonate may be 1 to 10 wt % based on the total weight of the solid detergent. When the content of the sodium hydrogen carbonate is less than 1 wt %, detergency may be lowered, and when the content of the sodium hydrogen carbonate is more than 10 wt %, a user's skin may be damaged.

The solid detergent may be manufactured by compressing a mixture including a sodium lauryl sulfoacetate powder, a sugar powder and a sodium hydrogen carbonate powder into tablets, and a moisture content of the mixture may be 6 wt % or less, and preferably, more than 0 wt % and 6 wt % or less. The term “moisture content” used herein refers to the weight of water with respect to the total weight of a specific material containing moisture, which is expressed as a percentage. For example, the moisture content of the mixture containing moisture refers to the weight of moisture with respect to the total weight of the mixture, expressed as a percentage.

When the moisture content of the mixture is more than 6 wt %, processability of the mixture and the structural and morphological stability of the solid detergent may be degraded, and when the mixture does not substantially contain moisture, it is difficult to manufacture a solid detergent having a uniform shape by compressing the mixture due to friction between powder.

Although a conventional solid detergent separately used a binder to enhance binding strength between powder particles, since the binder may not only lower the disintegrability of the solid detergent but also lower detergency of the detergent even if being used in a small amount, because the binder is essentially water insoluble, which means that the conventional detergent is disadvantageous in terms of environmental friendliness.

A powder constituting the solid detergent, for example, a sugar powder, may include a predetermined amount of moisture, and therefore, the moisture content of the solid detergent may also be adjusted within a predetermined range. As described above, the sodium hydrogen carbonate powder may absorb the moisture in the process of mixing and compressing the powders for manufacturing the solid detergent, resulting in aggregation thereof, and thus the structural and morphological stability of the solid detergent may be enhanced.

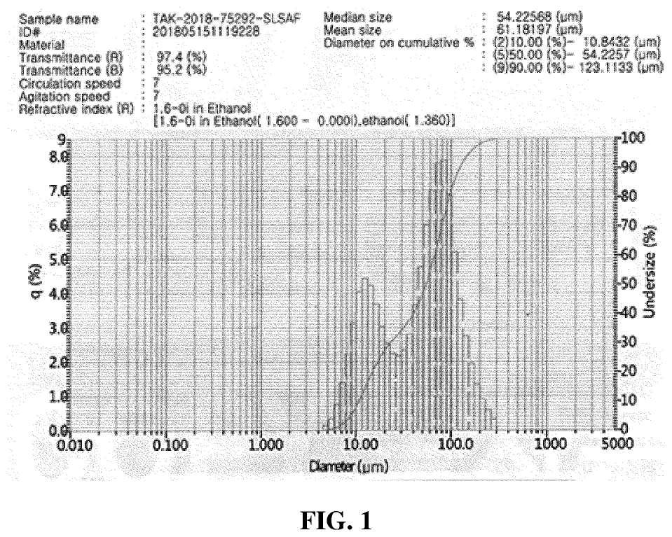

FIGS. 1 to 3 are respective particle size distribution curves for a sodium lauryl sulfoacetate powder, a dextrose powder and a sodium hydrogen carbonate powder according to an exemplary embodiment of the present invention.

The particle size of each powder is a critical factor for processing, that is, compressing the powder, as well as the moisture content. When the particle size of the powder is very large, a disintegration rate is lowered, and thus bubble generation and detergency may be reduced, and when the particle size of the powder is very small, unnecessary aggregation between powder particles is generated, resulting in a degradation in processability.

Referring to FIG. 1, the average particle size of the sodium lauryl sulfoacetate powder may be 40 to 80 μm. When the average particle size of the sodium lauryl sulfoacetate powder is less than 40 μm, processability may be lowered, and when the average particle size of the sodium lauryl sulfoacetate powder is more than 80 μm, disintegrability and detergency may be lowered.

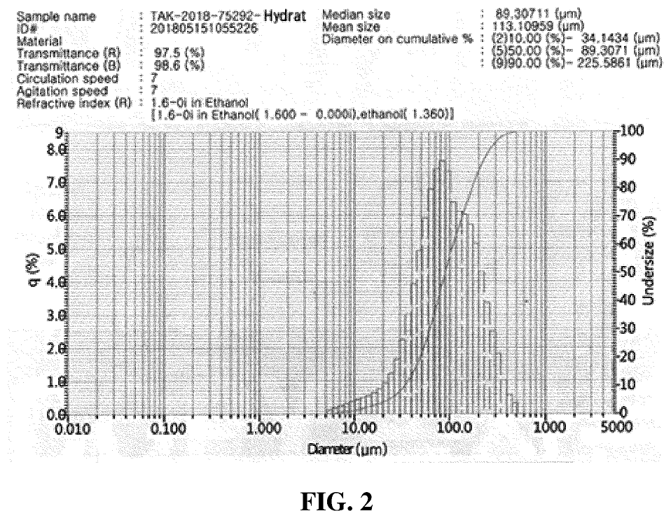

Referring to FIG. 2, the average particle size of the glucose powder may be 70 to 130 μm. When the average particle size of the glucose powder is less than 70 μm, processability may be lowered, and when the average particle size of the glucose powder is more than 130 μm, disintegrability and detergency may be lowered.

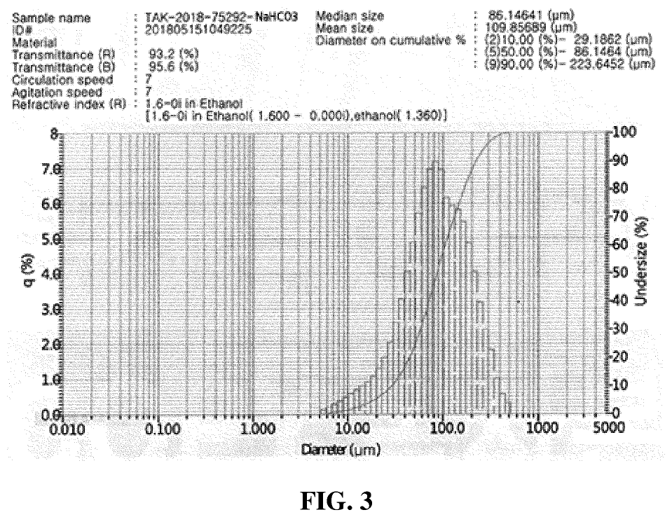

Referring to FIG. 3, the average particle size of the sodium hydrogen carbonate powder may be 60 to 120 μm. When the average particle size of the sodium hydrogen carbonate powder is less than 60 μm, processability may be lowered, and when the average particle size of the sodium hydrogen carbonate powder is more than 120 μm, disintegrability and detergency may be lowered.

Meanwhile, the sugar powder may further include a sucrose powder. The sucrose also called cane sugar or sugar, is prepared by combining glucose and fructose. The sucrose is a natural sweetener made by refining raw sugar obtained from sugar cane or sugar beets. In detail, the sucrose may be prepared by extracting liquid sugar from the stem of sugar cane or the root of a sugar beet, boiling and filtering the sugar solution to remove impurities, and crystallizing the resultant.

Since the sucrose powder has substantially the same action effect as the dextrose powder, the environmental friendliness of the solid detergent may be improved by replacing a part, for example, 20 wt % or more, and preferably, 50 wt % or more of the dextrose powder. Preferably, in the sugar powder, the content of the sucrose powder is 20 to 80 wt %. When the content of the sucrose powder is less than 20 wt %, bubble generation and detergency may be lowered, and when the content of the sucrose powder is more than 80 wt %, the durability of the solid detergent may be lowered.

The sucrose powder is dissolved in water in cleaning, such that a pollutant is attached to the sucrose molecule and removed, and thus, detergency may be maximized by realizing a synergistic effect with the sodium lauryl sulfoacetate. In addition, the sucrose powder may be decomposed by a microorganism after cleaning, and thus excellent environment friendliness and a protective effect on a user's skin may be exhibited.

The sucrose powder may be porous particles. The detergency of the solid detergent may be enhanced by forming abundant bubbles due to pores of the sucrose powder, which induce bubble formation.

The porous particles may have a porosity of 20 to 80 vol %. When the porosity of the porous particles is less than 20 vol %, bubble formation and detergency may be lowered, and when the porosity of the porous particles is more than 80 vol %, the durability of the solid detergent may be lowered.

Meanwhile, the mixture may have an apparent density of 0.5 to 1.5 g/cc, and the solid detergent may have an apparent density of 1.51 to 3.0 g/cc.

The term “apparent density” used herein refers to a calculated density of particles including voids between them. For example, as the apparent density of the compressed solid detergent is higher, there is less space and particles are more densely agglomerated. That is, the higher the apparent density, the stronger the binding between particles.

In the present invention, the mixture is formed by mixing a sodium lauryl sulfoacetate powder, a sugar powder and a sodium hydrogen carbonate powder, and the solid detergent may be formed by compressing the mixture using a tablet press, so that the binding strength between powder particles may increase. That is, the apparent density of the mixture may be increased through compression.

When the apparent density of the mixture is less than 0.5 g/cc, the durability of the solid detergent may be degraded, and when the apparent density of the mixture is more than 1.5 g/cc, detergency may be degraded. In addition, when the apparent density of the solid detergent is less than 1.51 g/cc, the durability of the solid detergent may be degraded, and when the apparent density of the solid detergent is more than 3.0 g/cc, detergency may be degraded.

Meanwhile, as needed, the solid detergent may further include a plant essential oil. The plant essential oil is a concentrated liquid extracted from the root, leaves, petals and roots of a plant, and since the plant essential oil is added to the solid detergent to emit a fragrance and exhibits a different effect depending on its type, in the present invention, the type of the plant essential oil may be selected according to a fragrance and an effect to be obtained.

Specifically, the plant essential oil may be one selected from the group consisting of eucalyptus, peppermint, lemongrass, palmarosa, lavender, chamomile, tea tree oils and a mixture of two or more thereof, but the present invention is not limited thereto.

The solid detergent may be manufactured in a cylindrical or coin type. Here, the diameter of the solid detergent is adjusted within the range of 7 to 30 mm, and thus the solid detergent may be individually packaged. When the diameter of the solid detergent is less than 7 mm, the detergent may become excessively small, and thus processability and cleaning sustainability may be degraded, and when the diameter of the solid detergent is more than 30 mm, bubble generation and detergency may be reduced.

The solid detergent adjusted to the above range may be included at an amount necessary for cleaning one or more times, and thus may be easily carried and stored and hygienically managed since the external exposure time is reduced.

In addition, although the individual packaging is formed with a safety cap including an inner cap and an outer cap, and thus can be opened easily by a uniform external force, it is difficult to open with the power of an infant or child, which indicates excellent safety.

Hereinafter, examples of the present invention will be described in detail.

### Example 1

A mixture in which a moisture content was adjusted to 5 wt % was prepared by mixing 35 wt % of a sodium lauryl sulfoacetate powder having an average particle size of about 61.18 μm, 60 wt % of a dextrose monohydrate powder having an average particle size of about 113.11 μm, and 5 wt % of a sodium hydrogen carbonate powder having an average particle size of about 109.86 μm. A coin-type solid detergent having a size of 30 mm (diameter)×5 mm (height) was manufactured by compressing the mixture using a tablet press under a pressure of 10 tons.

### Example 2

A solid detergent was manufactured by the same method as described in Example 1, except that a mixture having a moisture content of 4% was prepared by adjusting contents of respective powders to 40 wt % of a sodium lauryl sulfoacetate powder, 50 wt % of a dextrose monohydrate powder and 10 wt % of a sodium hydrogen carbonate powder.

### Example 3

A solid detergent was manufactured by the same method as described in Example 1, except that a mixture having a moisture content of 6% was prepared by adjusting contents of respective powders to 27 wt % of a sodium lauryl sulfoacetate powder, 70 wt % of a dextrose monohydrate powder and 3 wt % of a sodium hydrogen carbonate powder.

### Example 4

A solid detergent was manufactured by the same method as described in Example 1, except that a mixture having a moisture content of 3% was prepared by further including 50 wt % of a sucrose powder having a porosity of 50 vol % with respect to the total weight of a dextrose monohydrate powder.

### Comparative Example 1

A solid detergent was manufactured by the same method as described in Example 1, except that a mixture having a moisture content of 3.8% was prepared by adjusting contents of respective powders to 45 wt % of a sodium lauryl sulfoacetate powder, 45 wt % of a dextrose monohydrate powder and 10 wt % of a sodium hydrogen carbonate powder.

### Comparative Example 2

A solid detergent was manufactured by the same method as described in Example 1, except that a mixture having a moisture content of 7% was prepared by adjusting contents of respective powders to 20 wt % of a sodium lauryl sulfoacetate powder, 75 wt % of a dextrose monohydrate powder and 5 wt % of a sodium hydrogen carbonate powder.

### Comparative Example 3

A solid detergent was manufactured by the same method as described in Example 1, except that a mixture having a moisture content of 0% was prepared by including 60 wt % of an anhydrous dextrose powder instead of a dextrose monohydrate powder.

### Comparative Example 4

A solid detergent was manufactured by the same method as described in Example 1, except that a mixture having a moisture content of 5% was prepared by adjusting contents of respective powders to 39.5 wt % of a sodium lauryl sulfoacetate powder, 60 wt % of a dextrose monohydrate powder and 0.5 wt % of a sodium hydrogen carbonate powder.

### Comparative Example 5

A solid detergent was manufactured by the same method as described in Example 1, except that a mixture having a moisture content of 5% was prepared by adjusting contents of respective powders to 29 wt % of a sodium lauryl sulfoacetate powder, 60 wt % of a dextrose monohydrate powder and 11 wt % of a sodium hydrogen carbonate powder.

### Experimental Example 1: Apparent Density of Detergent

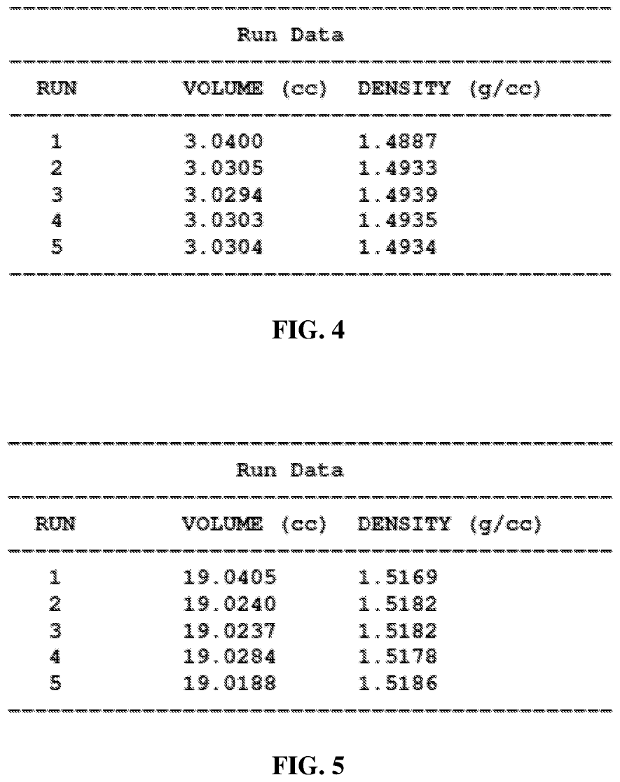

FIGS. 4 and 5 respectively show the results of measuring apparent densities of the powder mixture and the solid detergent according to Example 1. Referring to FIGS. 4 and 5, average values obtained through measuring the apparent densities of the powder mixture and the solid detergent according to Example 1 five times were 1.4936 g/cc and 1.5182 g/cc, respectively, indicating that the apparent densities were increased by aggregation of the powders through compression and a reduction in volume of pores in the powders. Particularly, it can be seen that the structure and morphology of the solid detergent may be stably realized at an apparent density higher than 1.5 g/cc.

### Experimental Example 2: Evaluation of Detergent Performance

TABLE 1

| | Degree of | | | | |
|---|---|---|---|---|---|
| Classifi- | bubble | Disinte- | | | |
| cation | generation | grability | Detergency | Durability | Usability |
| Example 1 | ⊚ ⊚ | ⊚ ⊚ | ⊚ ⊚ | ⊚ ⊚ | ⊚ ⊚ |
| Example 2 | ⊚ ⊚ | ⊚ ⊚ | ⊚ ⊚ | ⊚ ◯ | ◯ ⊚ |
| Example 3 | ⊚ ⊚ | ⊚ ⊚ | ⊚ ⊚ | ◯ | ◯ |
| Example 4 | ⊚ ⊚ | ⊚ ⊚ | ⊚ ⊚ | ⊚ ⊚ | ⊚ ⊚ |
| Comparative | Δ | Δ | Δ | Δ | Δ |
| Example 1 | | | | | |
| Comparative | Δ | Δ | Δ | X | X |
| Example 2 | | | | | |
| Comparative | X | X | X | X | X |
| Example 3 | | | | | |
| Comparative | Δ | Δ | Δ | X | X |
| Example 4 | | | | | |
| Comparative | Δ | Δ | Δ | X | X |
| Example 5 | | | | | |

Degree of bubble generation: Product comparison in bubble generation and maintenance when detergent was used
Disintegrability: Evaluation of rates of dissolving detergent in water when detergents were used
Detergency: Evaluation of conditions of dishes after cleaning
Durability: Product comparison in degree of crumbling or breaking when detergent was used
Usability: Product comparison in ease of use when detergent was used
(Relative evaluation standard: ⊚ - excellent, ◯ - good, Δ - moderate, X - bad)

Referring to Table 1, it was shown that the solid detergent (Example 1) manufactured using a mixture having moisture content of 5%, which includes a sodium lauryl sulfoacetate powder, a dextrose monohydrate powder and a sodium hydrogen carbonate powder was evaluated to be excellent in all aspects of performance evaluation (degree of bubble generation, disintegrability, detergency, durability, and usability).

In addition, the solid detergents (Examples 2 and 3) manufactured using mixtures in which moisture contents were adjusted to 4% and 6%, respectively, by adjusting the content of a dextrose monohydrate powder were evaluated to be excellent or good in all aspects of performance evaluation while there were little difference between them, and the solid detergent (Example 4) manufactured by further including a sucrose powder was evaluated to be excellent in all aspects of performance evaluation, which was the same as Example 1. Particularly, it is expected that a solid detergent will exhibit excellent detergency due to the synergistic effect with another type of powder.

On the other hand, in the case of the solid detergents (Comparative Examples 1 and 2) including an excessively small or large amount of a dextrose monohydrate powder, the structural and morphological stability of the solid detergent was degraded, resulting in degradation in durability and usability, and particularly, since the solid detergent manufactured using the mixture having a moisture content of 7% became easily soft, it was difficult to continuously generate and maintain bubbles, and thus exhibited poor durability and usability.

In addition, the solid detergent (Example 3) manufactured using a mixture having a moisture content of 0% by including an anhydrous dextrose powder as a sugar powder had degraded binding and binding retention between powder particles, resulting in poor results in all aspects of performance evaluation.

Meanwhile, when the sodium hydrogen carbonate powder was contained in an excessively small or large amount (Comparative Examples 4 or 5), the aggregation strength of each powder may be lowered, and thus all aspects of performance evaluation were deteriorated, and particularly, durability and usability were poor.

### Experimental Example 3: Evaluation of Skin Protection Performance of Detergent

The skin protection performance of solid detergents according to the Examples was evaluated as follows.

To evaluate the skin protection performance of the solid detergents according to a surfactant involved in skin damage, Example 1 as an experimental group and a solid detergent including a conventional sulfate-based surfactant as a control were used for an experiment.

For the experiment, 10 rabbits were used as experimental subjects, and before the introduction into the experiment, the health conditions of all individuals were visually examined and healthy individuals were used for the experiment after 8 days of quarantine and acclimation.

The dorsal areas of the 10 rabbits were shaved, and immediately before treatment, two treatment sections with an area of 2.5 cm×2.5 cm were classified into a scratched area and an unscratched area and two control sections were classified into a scratched area and an unscratched area. In each scratched area, scratching was carried out to the extent that only the epidermis, not the dermis, was damaged.

Gauzes soaked with 0.5 mL of the solid detergent according to Example 1 were attached to treatment sections (scratched area 1, unscratched area 1) of each of the 10 experimental subjects, gauzes soaked with 0.5 mL of a sulfate-based solid detergent were attached to control sections (scratched area 1 and unscratched area 1) of each of the 10 experimental subjects, and then the areas were fixed with a non-irritative tape and an elastic bandage without removal of the gauzes. After 24 hours, the gauzes were removed, and the material remaining on the skin was cleaned.

After 72 hours, the experimental subjects were evaluated for erythema, edema and the primary irritation index (P.I.I.). Here, the evaluation criteria and results are respectively shown in Tables 2 and 3 below.

TABLE 2

| Evaluation | Evaluation | |
|---|---|---|
| criteria for | criteria for | |
| erythema formation | edema formation | P.I.I. |
| No erythema | No edema | 0.0 to 0.5 |
| (0 point) | (0 point) | (non-irritative) |
| Very mild erythema | Very mild edema | 0.6 to 2.0 |
| (1 point) | (1 point) | (weakly irritative) |
| Obvious erythema | Mild edema | 2.1 to 5.0 |
| (2 points) | (2 points) | (moderately irritative) |
| Slightly severe erythema | Moderate edema | 5.1 to 8.0 |
| (3 points) | (3 points) | (strongly irritative) |
| Severe erythema | Severe edema | |
| (4 points) | (4 points) | |

TABLE 3

| Classification | Erythema | Edema | P.I.I. |
|---|---|---|---|
| Experimental Group (Example 1) | 0 | 0 | 0.3 |
| Control (sulfate-based detergent) | 3 | 2 | 4.2 |

Referring to Table 3, it was shown that, when sodium lauryl sulfoacetate, which is a natural surfactant, was included (Example 1), erythema and edema were not formed, and the P.I.I. was 0.3, indicating an excellent skin protection effect. On the other hand, in the case of the sulfate-based detergent, which includes a synthetic surfactant, erythema and edema were formed, and the P.I.I. was 4.2, indicating the moderate level of skin irritation.

It should be understood by those of ordinary skill in the art that the above description of the present invention is exemplary, and the exemplary embodiments disclosed herein can be easily modified into other specific forms without departing from the technical spirit or essential features of the present invention. Therefore, the exemplary embodiments described above should be interpreted as illustrative and not limited in any aspect. For example, components described as a single form may be dispersed, and components described as being dispersed may also be implemented in a combined form.

A solid detergent according to an aspect of the present invention can have increased environmental friendliness and improved detergency since it is manufactured by adding a sugar powder to a natural surfactant. Particularly, since the mixture prepared in a powder form can be compressed into tablets without a binder, disintegrability and bubble generation in cleaning are facilitated, and thus detergency can be enhanced.

In addition, the solid detergent is compressed into tablets and thus can be easily stored, and the overuse of the solid detergent can be prevented compared to a liquid detergent. Therefore, environmental protection and economic effects can be exhibited.

It should be understood that the effects of the present invention are not limited to the above-described effects, and include all effects that can be deduced from the descriptions disclosed in the detail description or claims of the present invention.

The scope of the present invention is defined by the appended claims and encompasses all modifications and alterations derived from meanings, the scope and equivalents of the appended claims.

What is claimed is:

1. A solid detergent, which is manufactured by compressing a mixture comprising 20 to 40 wt % of a sodium lauryl sulfoacetate powder; 50 to 70 wt % of a sugar powder; and 1 to 10 wt % of a sodium hydrogen carbonate powder into tablets,
wherein the sugar powder includes dextrose and sucrose powders.

2. The solid detergent according to claim 1, wherein the mixture has a moisture content of 6 wt % or less.

3. The solid detergent according to claim 1, wherein the content of the sucrose powder in the sugar powder is 20 to 80 wt %.

4. The solid detergent according to claim 1, wherein the sucrose powder is porous particles.

5. The solid detergent according to claim 4, wherein the porous particles have a porosity of 20 to 80 vol %.

6. The solid detergent according to claim 1, wherein the mixture has an apparent density of 0.5 to 1.5 g/cc, and the solid detergent has an apparent density of 1.51 to 3.0 g/cc.

7. The solid detergent according to claim 1, wherein the solid detergent has a diameter of 7 to 30 mm.
